(19) United States
(12) Patent Application Publication
(10) Pub. No.: US 2009/0100871 A1
(43) Pub. Date: Apr. 23, 2009

(54) METHOD FOR MANUFACTURING A SILICA GLASS BLOCK

(75) Inventors: Jiro Sawazaki, Sabae-shi (JP); Choji Sanada, Sabae-shi (JP)

Correspondence Address: TIAJOLOFF & KELLY, CHRYSLER BUILDING, 37TH FLOOR, 405 LEXINGTON AVENUE, NEW YORK, NY, 10174, US

(73) Assignees: HERAEUS QUARZGLAS GMBH & CO. KG, Hanau (DE); SHIN-ETSU QUARTZ PRODUCTS CO., LTD., Tokyo (JP)

(21) Appl. No.: 12/253,036

(22) Filed: Oct. 16, 2008

(30) Foreign Application Priority Data
Oct. 17, 2007 (JP) JP2007-270304

(51) Int. Cl. C03B 20/00; C03B 5/00

(52) U.S. Cl. 65/35; 65/83

(57) ABSTRACT

A method for manufacturing a silica glass block is provided in which, by markedly reducing the bubbles within the silica glass block, the quality of a silica glass block can be improved, contamination of the silica glass block can be prevented, and the yield of the silica glass block can be improved. The method comprises preparing a natural or synthetic silica raw material powder, packing the silica raw material powder into a glass fusing furnace, preheat treating the silica raw material powder packed into the fusing furnace, heating and fusing the heat preheat-treated silica raw material powder, and cooling a silica glass melt fused in the fusing furnace. The silica raw material powder packed into the fusing furnace is closely packed in the packing step, and an evacuation and a rare gas or H₂ gas introduction treatment is performed in the preheat treating step.

### TECHNICAL FIELD

The present invention relates to a method for manufacturing a silica glass block, and more particularly a large silica glass block (diameter no less than 1500 mm and thickness no less than 350 mm).

### PRIOR ART

An example of a known conventional method for manufacturing a large silica glass block such as this is disclosed in Patent Document 1. FIG. 7 is a flow chart showing the process sequence for a conventional method for manufacturing a silica glass block. In this conventional method, as shown in FIG. 8, a silica raw material powder 12 is charged into a fusing furnace 10 constituted from a furnace floor 10a and furnace wall 10b formed from refractory bricks (zirconia or aluminium or the like) (Step 200 of FIG. 8(a) and FIG. 7). Next, heat 16 is applied by heating means or heating apparatus 14 provided in an upper portion of the fusing furnace 10 to fuse the silica raw material powder 12 (Step 202 of FIG. 8(b) and FIG. 7). A thus-obtained fused-state silica glass melt 12a is cooled to produce a silica glass from which a silica glass block 18 is manufactured (Step 204 of FIG. 8 (c) and FIG. 7). FIG. 10 shows the relationship between the furnace temperature and heating time in the fusing step of the conventional method described above.

Initially, in the conventional method described above, the silica raw material powder 12 is charged into the fusing furnace 10. While charging the silica raw material powder 12 involves, as shown in FIG. 9, the silica raw material powder 12 being directly charged into the fusing furnace 10 through a raw material drum 20, the powder is blown about as the silica raw material powder 12 is being charged and, as a result, multiple layers (stratified bubbles) are formed.

Next, without further alteration to the state thereof (loosely packed state in the absence of a powder compacting treatment), the silica raw material powder charged into the fusing furnace is subjected to a preheat treatment. Accordingly, the bubbles are thought to be directly formed from these gaps in the silica raw material powder.

While in the conventional method, as shown in FIG. 10, the temperature is raised to the temperature at which fusing is possible (no less than 1750° C.) in a vacuum atmosphere (no more than 0.1 Torr) in a single action to fuse the silica raw material powder subsequent to the silica raw material powder having been charged into the furnace, the moisture and gases generated from within the silica raw material powder and from the furnace material from which the fusing furnace is constituted are not satisfactorily released and remain in the form of air bubbles in the silica glass block. The presence of air bubbles in the interior of a silica glass block formed in this way is directly linked to a drop in the quality of the silica glass block and, accordingly, presents a major problem.

In addition, while the furnace wall and furnace floor are formed using refractory bricks (zirconia or aluminium or the like) as the furnace material and the silica raw material powder is charged and fused therein, the direct contact of the silica raw material powder with the refractory bricks results in a problem of severe contamination from the refractory bricks and, in turn, a marked drop in the manufactured product yield.

[Patent Document 1] Japanese Laid-Open Patent Application No. S56-169137

### DISCLOSURE OF THE INVENTION

### Problems to be Solved by the Invention

With the foregoing problems of the prior art in mind, it is an object of the present invention to provide a method for manufacturing a silica glass block in which, by markedly reducing the bubbles within the silica glass block, the quality of a silica glass block can be improved, contamination of the silica glass block can be prevented, and the yield of the silica glass block can be improved.

### Means to Resolve the Problems

The method for manufacturing a silica glass block for resolving the problems described above constitutes a method for manufacturing a silica glass block comprising:

a preparing step for preparing a natural or synthetic silica raw material powder;

a packing step for packing the aforementioned silica raw material powder into a glass fusing furnace having a furnace floor and furnace walls formed from refractory bricks;

a preheat treating step for preheat treating the silica raw material powder packed into the aforementioned fusing furnace to remove moisture and gas therefrom;

a fusing step for heating and fusing the aforementioned heat preheat-treated silica raw material powder; and

a cooling step for cooling a silica glass melt fused in the aforementioned fusing furnace to produce a silica glass block,

characterized in that the silica raw material powder packed into the aforementioned fusing furnace is closely packed in the aforementioned packing step to a packing density of a range no less than 1.4 g/cm³ and no more than 1.6 g/cm³, and an evacuation and a rare gas or H₂ gas introduction treatment is performed in the aforementioned preheat treating step.

The silica raw material powder employed in the aforementioned preparing step contains at least 95 wt % of silica powder particles of particle diameter in the range 355 μm to 106 μm, and the impurities contained in the silica raw material powder are ideally Na: no more than 0.5 ppm, K: no more than 0.8 ppm, Li: no more than 1.5 ppm, Mg: no more than 0.3 ppm, Ca: no more than 1 ppm, Al: no more than 25 ppm, Fe: no more than 0.5 ppm and Cu: no more than 0.1 ppm.

While vibration must be applied to the silica raw material powder packed into said receptacle to raise the packing density thereof, as means for applying the aforementioned vibration, a rod-type vibrator having a surface covered with a silica glass layer is employed as aforementioned means for applying vibration, the silica raw material powder is compacted as a result of the rod-type vibrator being inserted into the silica raw material powder and vibrated, the frequency of the aforementioned vibrator is between 200 and 250 Hz, and the aforementioned vibrator is inserted into 400 to 900 cm² areas of the aforementioned silica raw material powder.

In a preferred configuration a silica glass plate or a molybdenum sheet is disposed in the furnace floor and furnace wall of the aforementioned fusing furnace to prevent the aforementioned silica raw material powder from coming into direct contact with the refractory bricks. The adoption of a contact-preventing structure based on the use of silica glass plate or molybdenum sheet such as this is advantageous in that the silica raw material powder is prevented from coming into direct contact with the refractory bricks and, accordingly, contamination of the silica glass block from the refractory bricks is prevented.

In an ideal configuration a furnace temperature program of the preheat treatment for removing the aforementioned moisture and gas of the aforementioned preheat treatment includes a step for maintaining a temperature range of between 900° C. and 1500° C. in a rare gas or H₂ gas atmosphere for between 4 to 12 hours prior to a fusing point of the silica raw material powder being reached (pressure 600 to 700 Torr), and for performing an evacuation and rare gas or H₂ gas introduction treatment at least twice during this preheat treatment.

In a preferred configuration, a furnace temperature program for heating and fusing the aforementioned preheat-treated silica raw material powder of said fusing step includes a step for maintaining a temperature range of between 1750° C. and 1900° C. in a vacuum atmosphere (no more than 0.5 Torr) for between 70 to 90 hours.

In the aforementioned cooling step, the cooling treatment may use natural cooling and, in addition, a forced slow-cooling treatment may be administered in order to facilitate an even more gradual cooling than that afforded by natural cooling.

### EFFECTS OF THE INVENTION

As the quality of a silica glass block can be improved, contamination of the silica glass block can be prevented, and the yield of the silica glass block can be improved by markedly reducing the bubbles within the silica glass block, the effects of the method for manufacturing a silica glass block of the present invention are significant.

### BEST MODE FOR CARRYING OUT THE INVENTION

While the present invention will be hereinafter described with reference to the embodiment modes thereof, it is to be understood that the embodiment modes are provided for illustration alone, and that modifications with the scope of the technical concept of the invention may be made thereto.

FIG. 1 is a flow chart showing the process sequence of the method for manufacturing a silica glass block of the present invention. The process sequence of the method for manufacturing a silica glass block will be described with reference to FIG. 1. FIG. 2 is a schematic cross-sectional explanatory diagram of the fusing furnace employed in the method for manufacturing a silica glass block of the present invention of which (a) shows a state in which a silica raw material powder has been charged into a fusing furnace, (b) shows a state in which a silica raw material powder charged into a fusing furnace has been fused by heating, and (c) shows a state in which a manufactured silica glass block has been removed from a fusing furnace. The basic configuration of the fusing furnace employed in the present invention is the same as the conventional fusing furnace shown in FIG. 8, and identical component members thereof are described using identical reference symbols. FIG. 3 is a schematic cross-sectional explanatory diagram showing a mode in which a silica raw material powder is charged into a fusing furnace employing a hopper arranged in the fusing furnace of which (a) shows a mode in which the silica raw material powder has been charged using a hopper arranged in the centre section, and (b) shows a mode in which the silica raw material powder has been charged using a hopper arranged in the upper portion. FIG. 4 is a schematic cross-sectional explanatory diagram showing a mode for administering a powder compacting treatment on the silica raw material powder charged into the fusing furnace of which (a) shows a state in which a silica raw material powder lies in a loosely-packed state as a result of the silica raw material powder having being simply charged into the fusing furnace, and (b) shows a state in which the silica raw material powder lies in a closely-packed state as a result of a powder-compacting treatment having been administered on the silica raw material powder using a rod-type vibrator. FIG. 5 is a graph showing the control state of the furnace temperature and furnace atmosphere of the fusing furnace as a relationship between heating time and furnace temperature of which (a) is an explanatory diagram of a heating program of an embodiment mode, and (b) shows a heating program of working example 1. FIG. 6 is a diagram for explaining a method for extracting samples used in bubble testing a silica glass block obtained from the working examples and the comparative example of which (a) shows a silica glass block sample extraction device, and (b) shows a test area divided into ten sections of an extracted sample.

As shown in FIG. 2, a fusing furnace 10A employed in the present invention has a furnace floor 10a and furnace wall 10b formed from refractory bricks (zirconia or aluminium or the like), and is configured from a silica glass plate 10c disposed in such a way as to cover the furnace floor 10a and furnace wall 10b. Silica glass pieces or the like may be employed as the silica glass plate 10c employed to prevent direct contact of the silica raw material powder with the refractory bricks which cause contamination. In addition, replacing the silica glass plate with a molybdenum sheet can produce an identical contamination-prevention effect.

As the silica raw material powder employed in the method for the present invention, a silica raw material powder containing at least 95 wt % of a silica powder particles of particle diameter 355 μm to 106 μm is employed, and a silica raw material powder in which the impurities are Na: no more than 0.5 ppm, K: no more than 0.8 ppm, Li: no more than 1.5 ppm, Mg: no more than 0.3 ppm, Ca: no more than 1 ppm, Al: no more than 25 ppm, Fe: no more than 0.5 ppm and Cu: no more than 0.1 ppm is ideally employed.

Initially, in the method of the present invention, a silica raw material powder 12 is charged into a fusing furnace 10 (Step 100 of FIG. 2(a) and FIG. 1). As shown in FIGS. 3(a) and (b), the silica raw material powder charging involves a hopper 22 being arranged on the upper portion of the fusing furnace 10 with freedom to move vertically, and the hopper 22 being utilized to charge the silica raw material powder 12 into the fusing furnace 10. As described in the case of the conventional method shown in FIG. 10, charging the silica raw material powder in one action results in the fine powder being blown about and results in the formation of layers (stratified bubbles). In addition, as interruption to the charging also results in the formation of layers, the silica raw material powder must as far as possible be slowly and continuously charged without interruption. An appropriate silica raw material powder charging speed is 10 to 25 kg/min. In addition, in such a way as to prevent an excessive increase in a distance D between the surface of the silica raw material powder 12 and an outlet port of the hopper 22, the height of the hopper 22 is adjusted in response to the height of the charged silica raw material powder 12 and, from the standpoint of preventing the powder from being blown about, the silica raw material powder is preferably charged while a certain distance (100 to 200 mm) is maintained. As a result of the silica raw material powder 12 being charged into the fusing furnace 10 in this state, the generation of layers (stratified bubbles) in the silica glass block is as far as possible able to be prevented.

Next, in order to increase the packing density of the silica raw material powder 12 charged into the fusing furnace 10 and eliminate the gaps in the silica raw material powder 12, in an opened state of a cover (not shown in the diagram) of the fusing furnace 10, an operator inserts a rod-type vibrator 24 as shown in FIGS. 4(a) and (b) into the silica raw material powder 12 and compacts the powder by applying vibration to the silica raw material powder 12 (Step 102 of the packing step of FIG. 1). The frequency of the rod-type vibrator 24 employed to compact the powder is of the order of between 200 and 250 Hz and, in addition, the surface thereof is preferably covered by a silica glass. By compacting the powder with the rod-type vibrator 24 in this way, the packing density of the silica raw material powder 12 is changed from the loosely-packed state when the silica raw material powder 12 has been simply charged into the furnace of packing density of the order of 1.30 g/cm³ to a closely-packed state of packing density of the order of 1.50 g/cm³, and bubbles of 1 mm or more in size regarded as being the bubbles for which the formation thereof is attributable to gaps in the silica raw material powder 12 are able to be markedly reduced. Moreover, any means able to apply vibration to the silica raw material powder 12 is suitable as means for increasing the packing density of the silica raw material powder 12 packed into the fusing furnace 10 and, for example, the packing density of the silica raw material powder 12 may also be improved by vibrating the fusing furnace 10.

Next, the fusing furnace 10 temperature and the furnace atmosphere are controlled in accordance with the furnace temperature program shown in FIG. 5. That is to say, a vacuum atmosphere (of the order of 0.1 Torr) is established in the fusing furnace 10, a treatment gas (for example, rare gas such as an He gas or Ar gas or H₂ gas) is introduced into the fusing furnace 10 until the pressure therein reaches a pressure of the order of 600 to 700 Torr, heat 16 is applied by heating means 14 provided in the upper portion of the fusing furnace 10, the temperature is raised for between 4 to 12 hours until a temperature range for removing moisture and gases is reached (900 to 1500° C.), and this temperature is maintained for 4 to 12 hours. An evacuation and treatment gas introduction treatment are preferably implemented at least twice in the preheat treating step during the period when the temperature is maintained. As a result of this treatment, heat is applied to the silica raw material powder 12 of the charged silica raw material powder 12 located in the furnace floor 10a section, and the moisture and gases of the silica raw material powder 12 are completely removed (Step 104 of preheat treating step of FIG. 1).

After the preheat treatment described above is completed, heat 16 is further applied by heating means 14 provided in the upper portion of the fusing furnace 10, and the silica raw material powder 12 is fused to form a silica glass melt 12a (Step 106 of fusing step of FIG. 2(b) and FIG. 1). The fusing treatment of the silica raw material powder 12 of this fusing step is administered by maintaining a fusion temperature range (1750° C. to 1900° C.) in a vacuum atmosphere (no more than 0.5 Torr) for 70 to 90 hours.

The fused-state silica glass melt 12a is cooled to produce a silica glass from which a silica glass block 18A is manufactured (Step 108 of cooling step, of FIG. 2(c) and FIG. 1). While the cooling treatment of this cooling step needs only to utilize natural cooling, a forced slow-cooling treatment in accordance with a slow-cooling program may also be administered to afford cooling even slower than that afforded by natural cooling. Examples of this cooling program treatment include a program in which cooling is performed in a nitrogen gas or Ar gas atmosphere for between 36 and 48 hours.

While the structure of the fusing furnace 10A employed in the present invention is as shown in FIG. 2 to FIG. 4, the specific configuration of the fusing furnace suitable for employment in the working examples of the method for the present invention is shown in FIG. 11. The reference symbol 10B in FIG. 11 denotes the fusing furnace. The fusing furnace 10B is configured from an upper dome 101, chamber 102, lower dome 103, copper electrode 104, carbon electrode 105, carbon heat-insulating material 106, carbon heat-insulating material base plate 107, carbon heat-insulating furnace wall 108, carbon heater 109, crucible-side surface (zirconium brick) 110, zirconium bubble heat-insulating material 111, silica raw material powder 12, crucible-base surface (zirconium plate) 113, refractory (refractory brick) 114, base plate 115, packing material (zirconium sand) 116, and vacuum exhaust port 117. When operations for charging the silica raw material powder 12 and extracting the manufactured silica glass block and so on are performed, the chamber 102 is pulled sideways in its entirety.

### WORKING EXAMPLE

While the present invention will be hereinafter more specifically described with reference to the working examples, it is to be understood that the working examples are provided for illustration and are not limited thereto.

### Working Example 1

Employing a fusing furnace identical to the fusing furnace shown in FIG. 2 to FIG. 4, a silica glass block was manufactured in accordance with the process sequence shown in FIG. 1 by controlling the furnace temperature and furnace atmosphere in accordance with the furnace temperature program shown in FIG. 5(b). The sequence of the working example will be hereinafter more specifically described in accordance with the various steps thereof.

1) Silica Raw Material Powder Charging

Employing a fusing furnace as shown in FIG. 2(a) in which the furnace floor and the furnace wall are covered with a silica glass plate and in which a vertically-movable hopper is provided in the upper portion of the fusing furnace as shown in FIGS. 3(a) and (b), the silica raw material powder was initially charged into the hopper. The silica raw material powder used contained 96 wt % of a silica powder of particle diameter in the range 355 μm to 106 μm. As introduction of the silica raw material powder in one action results in the fine powder being blown about and, as a result, the formation of layers (stratified bubbles) and, in addition, interruption to charging also results in the formation of layers, the silica raw material powder must as far as possible be slowly and continuously charged without interruption. The charging speed was adjusted within the range of 10 to 25 kg/min. In addition, as shown in FIGS. 3(a) and (b), in such a way as to prevent an excessive increase in a distance D between the surface of the silica raw material powder and an outlet port of the hopper, the height of the hopper was adjusted in response to the height of the charged silica raw material powder, and the silica raw material powder was charged while the predetermined distance D (100 to 200 mm) was maintained. As shown in the later-described test results of the thus-obtained silica glass block, a marked reduction in the layers (stratified bubbles) formed in a conventional silica glass block was achieved by implementing this improved charging operation.

2) Powder-Compacting Treatment (Packing Step)

In order to raise the packing density of the charged silica raw material powder to remove gaps in the silica raw material powder, the rod-type vibrator (frequency 200 Hz and surface covered by silica glass) as shown in FIGS. 4(a) and (b) was inserted in the opened state of the cover of the fusing furnace into the charged silica raw material powder, and vibration was applied to the silica raw material powder to effect the compacting thereof. By using a rod-type vibrator to compact the powder in this way, the packing density of the charged silica raw material powder was changed from the loosely-packed state when the silica raw material powder 12 has been simply charged into the furnace of packing density of the order of 1.30 g/cm³ to a closely-packed state of packing density of the order of 1.50 g/cm³. By administering this compacting treatment on the charged silica raw material powder in this way, as shown by the later-described test results of the thus-obtained silica glass block, bubbles of 1 mm or more in size regarded as being the bubbles attributable to gaps in the silica raw material powder formed in a conventional silica glass block are able to be markedly reduced.

3) Moisture and Gas-Removing Preheat Treatment (Preheat Treating Step)

A vacuum atmosphere (0.1 Torr) was established in the fusing furnace, then He gas was introduced into the fusing furnace until the pressure reached 700 Torr and, as shown in FIG. 2, the temperature was raised to 1200° C. over 8 hours by heating means provided in the upper portion of the fusing furnace, and the temperature was maintained at 1200° C. for 10 hours. In addition, an evacuation (0.1 Torr) and He gas introduction treatment was performed twice during the period that the temperature was maintained at 1200° C. While the moisture and gas removal effect demonstrated in the preheat treatment is not marked if heat is not transmitted to the base of the charged silica raw material powder, by maintaining the temperature in the manner noted above and implementing the evacuation and He gas introduction treatment at least twice during this period, heat can be transmitted to the base of the charged silica raw material powder. As shown in the later-described test results of the thus-obtained silica glass block, a marked reduction in the bubbles formed in a conventional silica glass block that are attributable to moisture and gas present in the silica raw material powder can be achieved by implementing this moisture and gas-removing preheat treatment.

4) Fusing Treatment (Fusing Step)

Subsequent to the completion of the moisture and gas-removing preheat treatment described above, further heat was applied in a vacuum atmosphere (no more than 0.5 Torr) by heating means provided in the upper portion of the fusing furnace to raise the temperature to 1790° C., and the temperature was maintained at 1790° C. for 90 hours to fuse the charged silica raw material powder.

5) Cooling Treatment (Cooling Step)

The fused-state silica glass melt was cooled by natural cooling for approximately 36 hours in a nitrogen gas atmosphere at 0.95 atmospheric pressure to produce a silica glass block (diameter (1700 mm×height 620 mm).

As shown in FIG. 6(a), a sample 26 of thickness 10 mm (length 620 mm×width 1100 mm) was extracted from the block centre portion of the thus-obtained silica glass block 18 and, as shown in FIG. 6(b), the silica glass plate from which a 60 mm contaminated section above and below the sample 26 had been removed was divided into 10 areas A to J, and the bubbles in these areas A to J were counted. Table 1 shows the bubble test results for the sample 26 extracted in the manner described above. A comprehensive evaluation based on size and number of the bubbles was carried out and, as shown in Table 1, O denotes satisfactory, Δ denotes somewhat satisfactory, and x denotes unsatisfactory.

### Comparative Example 1

Apart from the furnace floor and the furnace wall of the fusing furnace not being covered by a silica glass plate, the raw material drum as shown in FIG. 9 being employed to charge the silica raw material powder (the hopper shown in FIG. 3 was not used), the powder-compacting treatment not being performed, the moisture and gas-removing preheat treatment not being performed, and an evacuation treatment alone being performed (gas introduction treatment not being performed), the silica glass block of this working example was manufactured by a process the same as that employed in Working Example 1, and a bubble test, for which the results thereof are shown in Table 1, was carried out the same way as in Working Example 1. In addition, a comparatively greater contamination from the furnace material in the thus-obtained silica glass block than in the silica glass block of Working Example 1 was confirmed.

### Comparative Example 2

Apart from the powder-compacting treatment not being performed, the moisture- and gas-removing preheat treatment not being performed, and an evacuation treatment alone being performed (gas introduction treatment not performed), the silica glass block of this working example was manufactured by a process the same as that employed in Working Example 1, and a bubble test, for which the results thereof are shown in Table 1, was carried out the same way as in Working Example 1.

### Comparative Example 3

Apart from the moisture and gas-removing preheat treatment not being performed and an evacuation treatment alone being performed (gas introduction treatment not performed), the silica glass block of this working example was manufactured by a process the same as that employed in Working Example 1, and a bubble test, for which the results thereof are shown in Table 1, was carried out the same way as in Working Example 1.

### Comparative Example 4

Apart from the powder-compacting treatment not being performed and a heat treatment and evacuation treatment being performed in the moisture and gas-removing preheat treatment (gas introduction treatment not performed), the silica glass block of this working example was manufactured by a process the same as that employed in Working Example 1, and a bubble test, for which the results thereof are shown in Table 1, was carried out the same way as in Working Example 1.

### Comparative Example 5

Apart from the powder-compacting treatment not being performed, the silica glass block of this working example was manufactured by a process the same as that employed in Working Example 1, and a bubble test, for which the results thereof are shown in Table 1, was carried out the same way as in Working Example 1.

### Comparative Example 6

Apart from a heat treatment and evacuation treatment being performed in the moisture and gas-removing preheat treatment (gas introduction treatment not being performed), the silica glass block of this working example was manufactured by a process the same as that employed in Working Example 1, and a bubble test, for which the results thereof are shown in Table 1, was carried out the same way as in Working Example 1.

The results described above confirmed that, in order to reduce bubbles in a silica glass block, a hopper must be used, a powder-compacting treatment must be performed, and a moisture and gas-removing preheat treatment must be performed. It is also clear from these results that formation of a cover of silica glass on the furnace floor and furnace wall of the fusing furnace is effective for preventing contamination of the silica glass block from the furnace material of the fusing furnace.

Notably, while the temperature employed in the moisture and gas-removing preheat treatment of Working Example 1 is indicated as being 1200° C., the same result was found to be able to be achieved in the temperature range between 900° C. to 1500° C. In addition, while He gas is employed as the rare gas of the moisture and gas-removing preheat treatment in Working Example 1, the same effect was found to be able to be obtained using Ar gas or other rare gas or a H₂ gas.

TABLE 1
BUBBLE TEST RESULTS

| | | | MOISTURE AND | BUBBLES | | | |
|---|---|---|---|---|---|---|---|
| | | | GAS-REMOVING | | MAXIMUM | | |
| | | POWDER | PREHEAT | | BUBBLE | BUBBLE | |
| | HOPPER | COMPACTION | TREATMENT | LAYERS | DIAMETER | NUMBER | EVALUATION |
| WORKING | YES | YES | HEAT TREATMENT + | NONE | Φ1 mm OR | FEW | ◯ |
| EXAMPLE 1 | | | EVACUATION + | | LESS | | |
| | | | TREATMENT GAS | | | | |
| | | | INTRODUCTION | | | | |
| COMPARATIVE | NO | NO | EVACUATION ONLY | MANY | Φ2 TO 3 mm | MANY | X |
| EXAMPLE 1 | | | | | | | |
| COMPARATIVE | YES | NO | EVACUATION ONLY | NONE | Φ2 TO 3 mm | MANY | X |
| EXAMPLE 2 | | | | | | | |
| COMPARATIVE | YES | YES | EVACUATION ONLY | NONE | Φ1 mm OR | COMPARATIVELY | Δ |
| EXAMPLE 3 | | | | | LESS | MANY | |
| COMPARATIVE | YES | NO | HEAT TREATMENT + | NONE | Φ1 mm OR | COMPARATIVELY | X-Δ |
| EXAMPLE 4 | | | EVACUATION | | MORE | MANY | |
| COMPARATIVE | YES | NO | HEAT TREATMENT + | NONE | Φ1 mm OR | FEW | Δ |
| EXAMPLE 5 | | | EVACUATION + | | MORE | | |
| | | | TREATMENT GAS | | | | |
| | | | INTRODUCTION | | | | |
| COMPARATIVE | YES | YES | HEAT TREATMENT + | NONE | Φ1 mm OR | COMPARATIVELY | Δ |
| EXAMPLE 6 | | | EVACUATION | | LESS | MANY | |

### BRIEF DESCRIPTION OF THE DRAWINGS

FIG. 1 is a flow chart showing the process sequence of the method for manufacturing a silica glass block of the present invention;

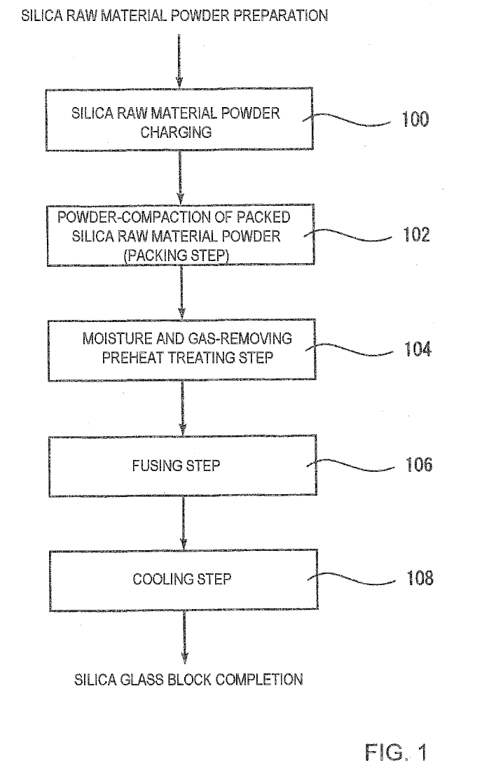

FIG. 2 is a schematic cross-sectional explanatory diagram of the fusing furnace employed in the method for manufacturing a silica glass block of the present invention of which (a) shows a state in which a silica raw material powder has been charged into a fusing furnace, (b) shows a state in which a silica raw material powder charged into a fusing furnace has been fused by heating, and (c) shows a state in which a manufactured silica glass block has been removed from a fusing furnace;

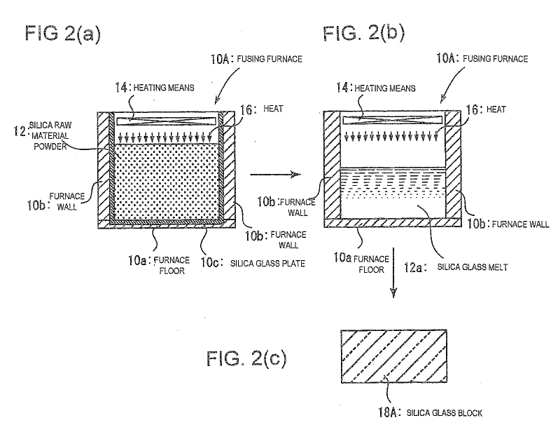

FIG. 3 is a schematic cross-sectional explanatory diagram showing a mode in which a silica raw material powder is charged into a fusing furnace employing a hopper arranged in the fusing furnace of which (a) shows a mode in which the silica raw material powder has been charged using a hopper arranged in the centre section, and (b) shows a mode in which the silica raw material powder has been charged using a hopper arranged in the upper portion;

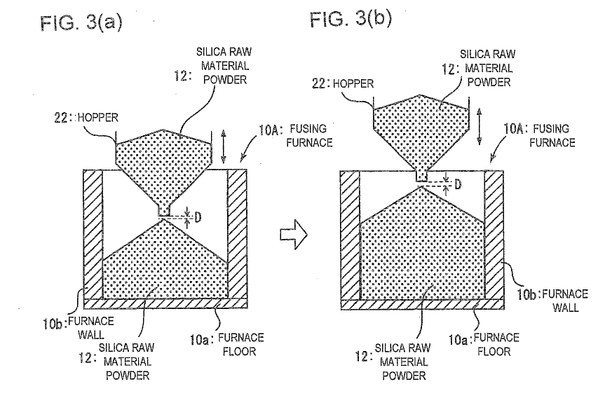

FIG. 4 is a schematic cross-sectional explanatory diagram showing a mode for administering a powder compacting treatment on the silica raw material powder charged into the fusing furnace of which (a) shows a state in which a silica raw material powder lies in a loosely-packed state as a result of the silica raw material powder having being simply charged into the fusing furnace, and (b) shows a state in which the silica raw material powder lies in a closely-packed state as a result of a powder-compacting treatment having been administered on the silica raw material powder using a rod-type vibrator;

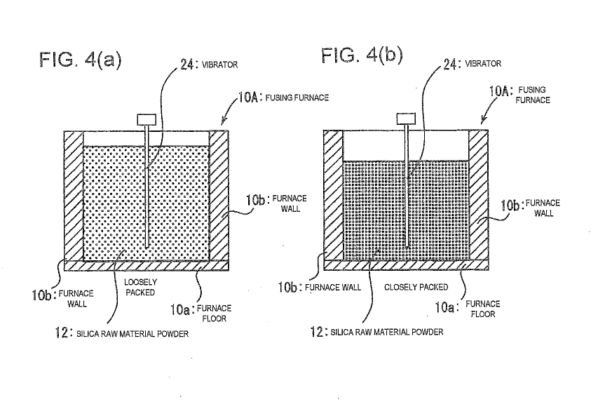

FIG. 5 is a graph showing the control state of the furnace temperature and furnace atmosphere of the fusing furnace as a relationship between heating time and furnace temperature of which (a) is an explanatory diagram of a heating program of an embodiment mode, and (b) shows a heating program of working example 1;

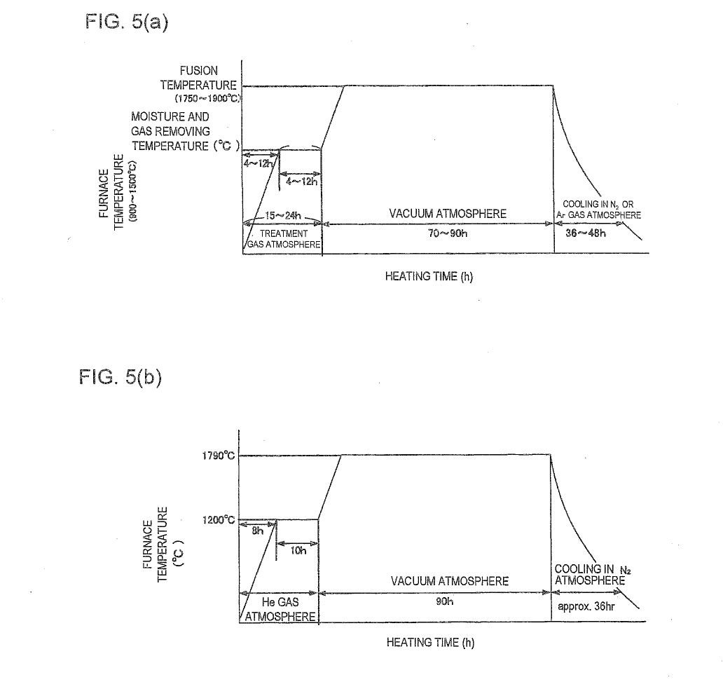

FIG. 6 is a diagram for explaining a method for extracting samples used in bubble testing a silica glass block obtained from the working examples and the comparative example of which (a) shows a silica glass block sample extraction device, and (b) shows a test area divided into ten sections of an extracted sample;

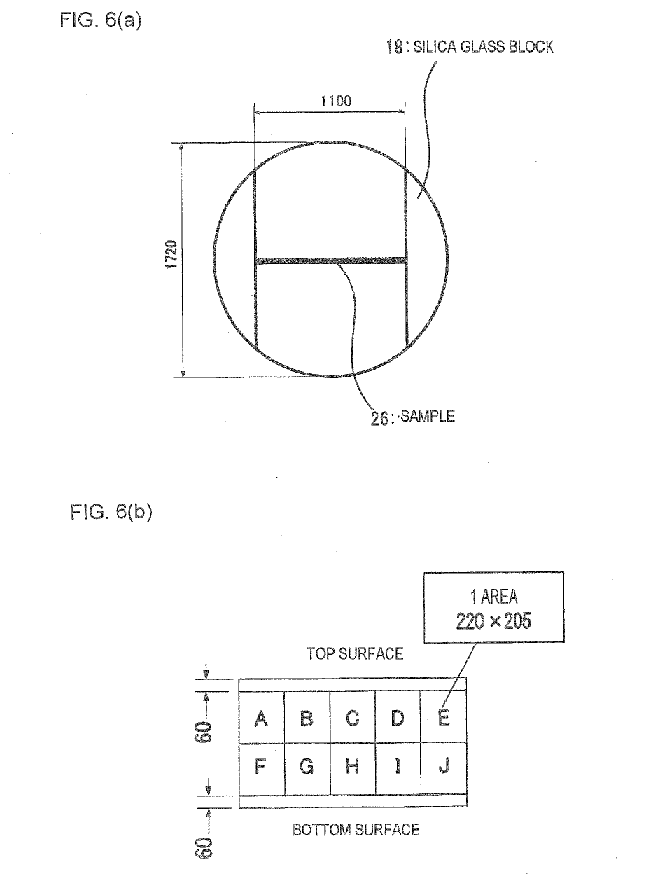

FIG. 7 is a flow chart showing the process sequence of a conventional method for manufacturing a silica glass block;

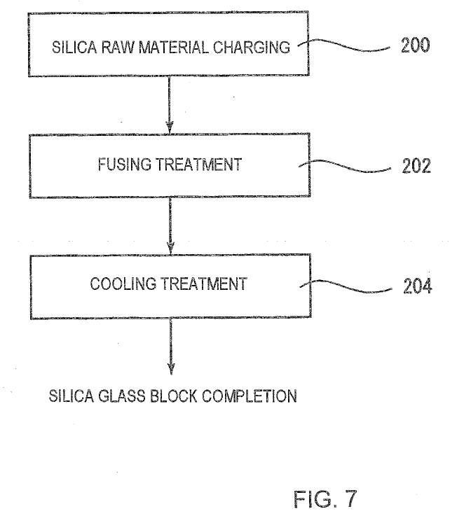

FIG. 8 is a schematic cross-sectional explanatory diagram of the fusing furnace employed in a convention method for manufacturing a silica glass block of which (a) shows a state in which a silica raw material powder has been charged into a fusing furnace, (b) shows a state in which a silica raw material powder charged into a fusing furnace has been fused by heating, and (c) shows a state in which a manufactured silica glass block has been removed from a fusing furnace;

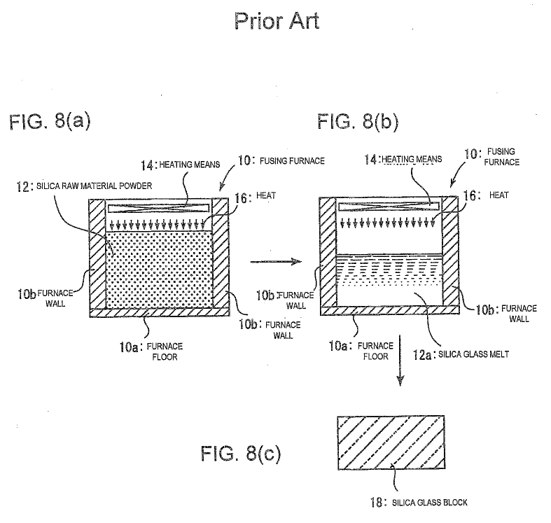

FIG. 9 is a schematic cross-sectional explanatory diagram of a conventional method showing a mode in which a silica raw material powder is charged into a fusing furnace employing a raw material drum;

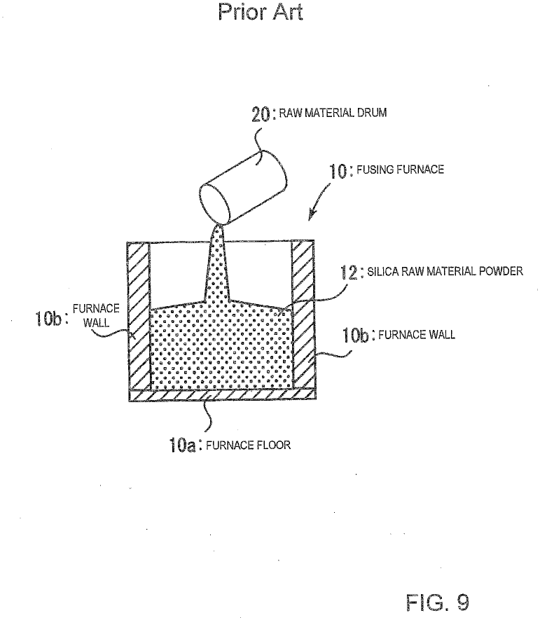

FIG. 10 is a graph showing the control state of the furnace temperature and furnace atmosphere of the fusing furnace as a relationship between heating time and furnace temperature of a conventional method; and

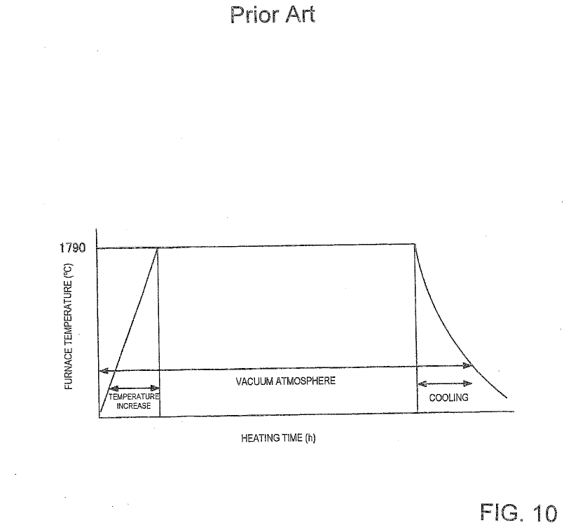

FIG. 11 is a partial cross-sectional diagram of a specific configuration of a fusing furnace ideal for employment in the working example of the present invention.

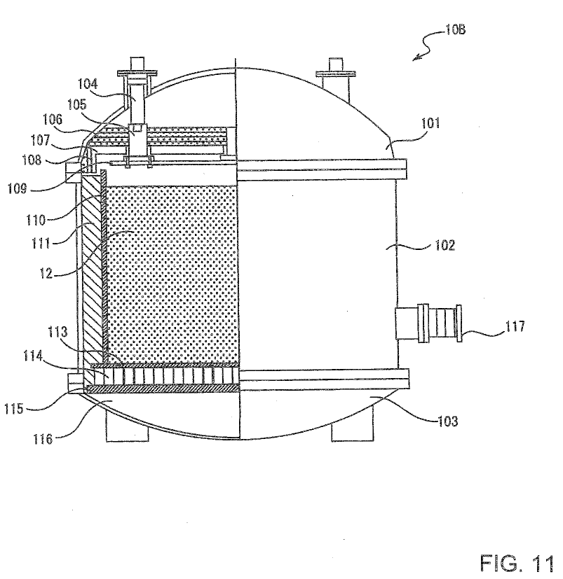

### EXPLANATION OF SYMBOLS

10: Conventional fusing furnace, 10A Fusing furnace employed in the present invention, 10a: Furnace floor, 10b: Furnace wall, 10c: Glass plate, 12: Silica raw material powder, 12a: Silica glass melt, 14: Heating means, 16: Heat, 18: Conventional silica glass block, 18A Silica glass block manufactured by the present invention, 20: Raw material drum, 22: Hopper, 24: Rod-type vibrator, 26: Sample, 101: Upper dome, 102: Chamber, 103: Lower dome, 104: Copper electrode, 105: Carbon electrode, 106: Carbon heat-insulating material, 107: Carbon heat-insulating material base plate, 108: Carbon heat-insulating furnace wall, 109: Carbon heater, 110: Crucible side surface, 111: Zirconia bubble heat-insulating material, 112: Silica raw material powder, 113: Crucible base surface, 115: Carbon base plate, 116: Packing material, 117: Vacuum exhaust port.

1. A method for manufacturing a silica glass block, said method comprising:
preparing a natural or synthetic silica raw material powder;
packing said silica raw material powder into a glass fusing furnace having a furnace floor and furnace walls formed from refractory bricks;
preheat treating the silica raw material powder packed into said fusing furnace to remove moisture and gas therefrom;
heating and fusing said heat preheat-treated silica raw material powder; and
cooling a silica glass melt fused in said fusing furnace to produce the silica glass block,
wherein the silica raw material powder packed into said fusing furnace is closely packed in said packing step to a packing density of a range no less than 1.4 g/cm³ and no more than 1.6 g/cm³, and wherein an evacuation and a rare gas or H₂ gas introduction treatment is performed in said preheat treating step.

2. The method for manufacturing a silica glass block according to claim 1, wherein said silica raw material powder employed in said preparing contains at least 95 wt % of silica powder particles of particle diameter in the range 100 μm to 400 μm.

3. The method for manufacturing a silica glass block according to claim 1, wherein vibration is applied to the silica raw material powder packed into said receptacle to increase the packing density thereof.

4. The method for manufacturing a silica glass block according to claim 3, wherein the vibration is applied by a rod-type vibrator having a surface covered with a silica glass layer, the silica raw material powder is compacted as a result of the rod-type vibrator being inserted into the silica raw material powder and vibrated, the vibrator having a frequency between 200 and 250 Hz, and said vibrator is inserted into 400 to 900 cm² areas of said silica raw material powder.

5. The method for manufacturing a silica glass block according to claim 1, wherein a silica glass plate or a molybdenum sheet is disposed on the furnace floor and furnace wall of said fusing furnace so as to prevent said silica raw material powder from coming into direct contact with the refractory bricks.

6. The method for manufacturing a silica glass block according to claim 1, wherein a furnace temperature program of the preheat treating removes said moisture and gas of said preheat treating and includes maintaining a temperature range of between 900° C. and 1500° C. in a rare gas or H₂ gas atmosphere for between 4 to 12 hours prior to a fusing point of the silica raw material powder being reached (pressure 600 to 700 Torr), and performing an evacuation and rare gas or H₂ gas introduction treatment at least twice during said preheat treating.

7. The method for manufacturing a silica glass block according to claim 1, wherein a furnace temperature program for heating and fusing said preheat-treated silica raw material powder of said fusing includes maintaining a temperature range of between 1750° C. and 1900° C. in a vacuum atmosphere with a pressure of no more than 0.5 Torr for between 70 to 90 hours.

8. The method for manufacturing a silica glass block according to claim 1, wherein the cooling includes natural cooling.
